(19) United States
(12) Patent Application Publication
(10) Pub. No.: US 2026/0087135 A1
(43) Pub. Date: Mar. 26, 2026

(54) SYSTEM AND METHOD FOR MALWARE CLASSIFICATION USING CONVOLUTIONAL NEURAL NETWORKS AND LONG SHORT-TERM MEMORY

(71) Applicant: The Regents of the University of Colorado, a body corporate, Denver, CO (US)

(72) Inventors: Jugal Kalita, Colorado Springs, CO (US); Ahmed Bensaoud, Colorado Springs, CO (US)

(21) Appl. No.: 19/176,133

(22) Filed: Apr. 10, 2025

Related U.S. Application Data
(60) Provisional application No. 63/632,388, filed on Apr. 10, 2024.

(51) Int. Cl. G06F 21/56

(52) U.S. Cl. CPC G06F 21/566; G06F 2221/034

(57) ABSTRACT

A malware classification system and method are based on application programming interface (API) calls and opcodes to improve classification accuracy. This system provides a combined convolutional neural network (CNN) and Long Short-Term Memory (LSTM). Opcode sequences and API calls are extracted from Windows malware samples for classification. The extracted features are transformed into selected gram sequences. Hyper parameters are calculated by using one or more shallow neural networks to model the relationships between the text of words based on their context. The invention improves malware classification performance on deep learning architectures.

### CROSS REFERENCE TO RELATED APPLICATION

This application claims the benefit of and priority to U.S. Provisional Application No. 63/632,388, filed Apr. 10, 2024. The entire specification and figures of the above-referenced application are hereby incorporated, in their entirety by reference.

### FIELD OF THE INVENTION

The invention relates to computer system security and more specifically to systems and methods for malware classification that use convolutional neural networks that are particularly effective for image recognition and processing, and the use of long short-term memory that is efficient in processing long-term dependencies in data.

### BACKGROUND OF THE INVENTION

Malware is malicious code that enters a computer or an internet-connected device and subsequently misappropriates sensitive information from government, commercial or private organizations. Internet-connected devices infected with malware can also destroy and/or gain access to confidential information, randomly reboot, track user activity, cause a device to run slower, start unknown processes, or send emails without user action. Classifying malware is complicated because most malware developers adopt strategies to avoid anti-virus systems. Reverse engineering of malware enables identification of how malware functions by monitoring runtime execution using dynamic analysis tools. Reverse engineering in general is a process of analyzing software to understand its design, functionality, and behavior. Reverse engineering is used in malware analysis to identify and understand the nature of malicious code. Reverse engineering can include disassembling code which involves converting the binary code of the malware into human-readable assembly language, which can then be analyzed to understand the behavior of the malware. Another important technique in reverse engineering is debugging which involves running the malware in a controlled environment and analyzing its behavior as it executes. This approach can help identify the specific functions and routines used by the malware, as well as any malicious behavior it exhibits. Reverse engineering can also be used to develop countermeasures to malware. By analyzing the code of a malware sample, researchers can identify its specific characteristics and develop tools and techniques to detect and remove it from infected systems.

One example of a system and method for malware classification is disclosed in the U.S. Pat. No. 10,366,233. This reference provides a computer-implemented method for trichotomous malware classification that may include (1) identifying a sample potentially representing malware, (2) selecting a machine learning model trained on a set of samples to distinguish between malware samples and benign samples, (3) analyzing the sample using a plurality of stochastically altered versions of the machine learning model to produce a plurality of classification results, (4) calculating a variance of the plurality of classification results, and (5) classifying the sample based at least in part on the variance of the plurality of classification results.

Another example of a method for malware classification is disclosed in the U.S. Pat. No. 11,861,006. This reference discloses a reference file set having high-confidence malware severity classification that is generated by selecting a subset of files from a group of files first observed during a recent observation period and including them in the subset. A plurality of other antivirus providers is polled for their third-party classification of the files in the subset and for their third-party classification of a plurality of files from the group of files not in the subset. A malware severity classification is determined for the files in the subset by aggregating the polled classifications from the other antivirus providers for the files in the subset after a stabilization period of time, and one or more files having a third-party classification from at least one of the polled other antivirus providers that changed during the stabilization period to the subset are added to the subset.

While the prior art may be adequate for its intended purposes, there is still a need for a malware classification system and method in which image recognition and processing can be optimized so that malware classification can be more quickly and efficiently achieved for large data structures being analyzed.

### SUMMARY OF THE INVENTION

According to the invention, transfer learning is effective for malware image classification tasks. Transfer learning involves taking a pretrained model that has been trained on a large dataset of non-malware images and fine-tuning it on a smaller dataset of malware images. By doing so, the model can learn to classify malware images with high accuracy without requiring as much labeled data. According to one aspect of the invention, transfer learning is used for malware image classification through a pre-trained convolutional neural network (CNN) as a feature extractor. The CNN is trained on a large dataset of non-malware images, and its weights are frozen. The malware images are then passed through the CNN to obtain feature vectors, which are then used to train a classifier. The classifier can be a simple linear classifier or a more complex model, such as a support vector machine (SVM) or a random forest.

According to another aspect of the invention, another approach is to fine-tune an entire pre-trained CNN on malware images. This approach involves unfreezing some or all the layers of the pre-trained CNN and then training them on malware images while also updating weights of a classifier being used. This aspect enables an entire model to be optimized for a malware classification task.

According to the invention in one preferred embodiment, malware is classified based on opcode sequences and API calls extracted from various complex malware. A model for malware family classification is based on CNN, LSTM, and imitation of Natural Language Processing (NLP) to increase the classification accuracy. CNNs can be effective at extracting latent features for non-sequential data like images while LSTM networks are effective for discovering dependence in sequential data. In combination, CNNs and LSTIM provide reliable and accurate malware classification. One rationale in accordance with the invention for using a CNN-LSTM model for malware classification is that a CNN model can filter out noise in feed data and extract valuable features, whereas a LSTM model can efficiently capture sequence pattern information. Advantages of both deep learning approaches can improve malware classification performance. Other features and advantages of the invention will become apparent from the following detailed description and accompanying figures.

### BRIEF DESCRIPTION OF THE DRAWINGS

FIG. 1 is a flow diagram of a method of the invention showing an architecture of malware detection for classification purposes; this figure is therefore intended to show an input program, a preprocessing module, a trainable multi-step classification module, and a final malware classification output in the form of malware family probabilities;

FIG. 2 is another flow diagram of the method of the invention providing details on aspects of the preprocessing module of FIG. 1. More specifically, FIG. 2 details the steps involved in transforming raw program text into opcode sequences. The preprocessing module extracts and parses operation instructions to create a structured representation. The resulting sequence serves as input to the classification module;

FIG. 3 is another flow diagram of the method of the invention providing details on aspects of the trainable classification module of FIG. 1. More specifically, FIG. 3 details the steps involved in providing a modular pipeline that transforms input opcode sequences into a malware classification. The trainable classification module includes capabilities for extracting features, learning temporal patterns, and classifying based on dependencies; accordingly, each stage incrementally builds a richer representation of the input data.

FIG. 4 is another flow diagram of the method of the invention providing details on aspects of computing complex statistical representations of FIG. 3. More specifically, FIG. 4 elaborates on how statistical representations of opcodes are generated. The representations include n-gram extraction and both sparse (TF-IDF) and dense representations that are later used for feature extraction;

FIG. 5 is another flow diagram of the method of the invention providing details on aspects of how to extract high level features of FIG. 3. More specifically, FIG. 5 elaborates on how CNN processes statistical features to derive abstract, high-level representations. The CNN uses multiple convolutional layers with exponential linear unit (ELU) neural network activation and max-pooling. Max pooling can be considered a technique used to downsample feature maps after a convolutional layer. The output of the extraction can form the basis for sequence modeling;

FIG. 6 is another flow diagram of the method of the invention providing details on learning sequence-based dependencies from FIG. 3. More specifically, FIG. 6 elaborates on how LSTM layers are used to learn sequential dependencies in the extracted features. The learning involves three stacked LSTM layers with 512 neurons each in which the desired result is a context-aware feature sequence; and

FIG. 7 is another flow diagram of the method of the invention providing details on classifying based on dependency-based representation from FIG. 3. More specifically, FIG. 7 explains the final classification step using a dense neural network in which the dependency-based representation is passed through fully connected and softmax layers. The fully connected and softmax layers are used as final classification means for the extracted features. These layers connect every neuron in the previous layer to every neuron in the next, allowing the learning of complex patterns and relationships between extracted features. The final classification is a set of malware family probabilities; and

FIG. 8 is a system diagram of the invention representing some of the functional aspects of the method of the invention in a graphical form. More specifically, this figure provides an example of a preferred embodiment of the invention in the form of a CNN-LSTM model with a hybrid architecture that first uses convolutional layers to extract spatial features from 8-gram sequences of API calls and opcodes. These extracted feature maps are then flattened and passed through a series of LSTM layers to learn temporal dependencies and contextual patterns.

Finally, the output from the LSTM layers is fed into fully connected layers to classify the input into corresponding malware families.

### DETAILED DESCRIPTION

According to the system and method of the invention, it may reside in cloud platform, a single computing device, or a network of computing devices in which adequate computer processing is provided to run one or more malware classification programs that are capable of independently or collectively generating malware classification outputs. Each computing device can be described as a general-purpose computer with elements that cooperate to achieve multiple functions normally associated with general purpose computers. For example, the hardware elements may include one or more central processing units (CPUs) for processing data. The computer may further include one or more input devices (e.g., a mouse, a keyboard, etc.); and one or more output devices (e.g., a display device, a printer, etc.). The computer may also include one or more storage devices. By way of example, storage device(s) may be disk drives, optical storage devices, solid-state storage device such as a random-access memory (“RAM”) and/or a read-only memory (“ROM”), which can be programmable, flash-updateable and/or the like.

Each computer may include a computer-readable storage media reader; a communications peripheral (e.g., a modem, a network card (wireless or wired), an infra-red communication device, etc.); working memory, which may include RAM and ROM devices as described above.

The computer-readable storage media reader can further be connected to a computer-readable storage medium, together (and, optionally, in combination with storage device(s)) comprehensively representing remote, local, fixed, and/or removable storage devices plus storage media for temporarily and/or more permanently containing computer-readable information.

The one or more malware classification programs can be described as various software elements with programmable code. It should be appreciated that alternate embodiments of a computer may have numerous variations from that described above. For example, customized hardware might also be used and/or particular elements might be implemented in hardware, software (including portable software, such as applets), or both. Further, connection to other computing devices such as network input/output devices may be employed.

It should also be appreciated that the method described herein may be performed in part by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The term “program” and “software” as may be used herein shall be broadly interpreted to include all information processed by a computer processor, a microcontroller, or processed by related computer executed programs communicating with the software. Software therefore includes computer programs, libraries, and related non-executable data, such as online documentation or digital media. Executable code makes up definable parts of the software and is embodied in machine language instructions readable by a corresponding data processor such as a central processing unit of the computer. The software may be written in any known programming language in which a selected programming language is translated to machine language by a compiler, interpreter, or assembler element of the associated computer. The invention may include a congregation of programmed modules that collectively form a program.

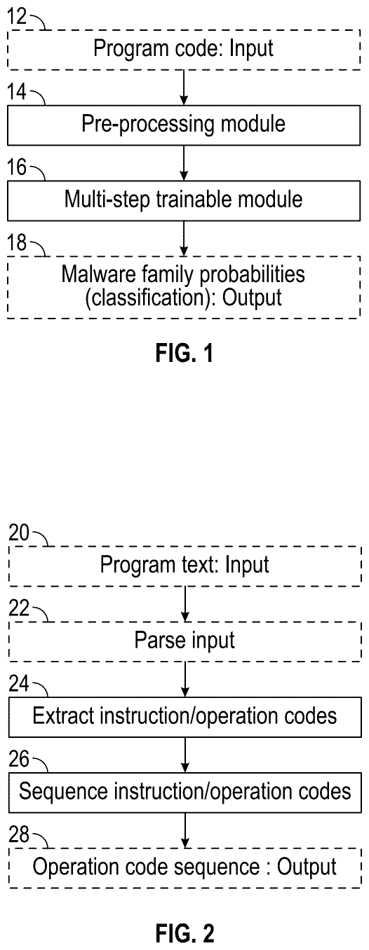

Referring to FIG. 1, it shows a flow diagram of a method of the invention showing an architecture of malware detection for classification purposes. At step 12, inputs to the overall malware detection system are provided, for example, the form of program code. During machine learning-based malware detection, the system of the invention is trained on a dataset of labeled inputs to learn the parameters of the machine-learning module. During testing, the trained module is directly used to classify an unknown example input program's code. At step 14, a preprocessing module executes initial parsing and transformation of raw program code. This module prepares structured opcode sequences for downstream processing. At step 16, a multi-step trainable module performs several learning tasks on features extracted from the pre-processed input. It includes CNN and LSTM layers to extract and learn from both spatial and sequential patterns. At step 18, malware family probabilities are generated as a final output layer of the system, wherein predicted probabilities are provided for each malware family class.

Referring to FIG. 2, this figure provides details on aspects of the preprocessing module of FIG. 1. At step 20, there is a program text input in which raw text from program code is input. This raw text serves as the initial source for opcode extraction. At step 22, the program text is parsed to extract syntactic elements. Parsing text can be considered a key step to understand and isolate instructions. At step 24, extraction occurs in which parses are translated into low-level instruction or operation codes. This step can be considered to distill the executable behavior of the code. At step 26, The extracted operation codes are ordered into sequences. This step preserves program execution flow for downstream learning. At step 28, the final result of the preprocessing step is provided in the form of a clean, structured sequence of opcodes. This sequence of opcodes is next passed to the multi-step trainable module.

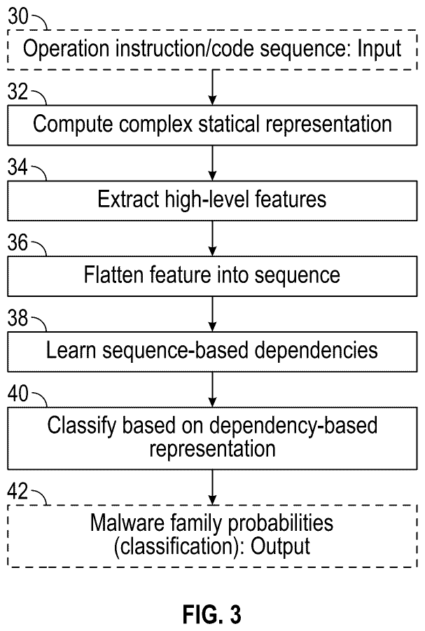

Referring to FIG. 3 this figure provides details on aspects of the trainable classification module of FIG. 1. At step 30, The pre-processed opcode sequence is input here. It forms the basis for further representation learning. At step 32, The opcode sequence is analyzed statistically using n-gram and vectorization techniques. This enhances understanding of frequency and co-occurrence patterns. At step 34, high-level features are extracted in which statistical features are passed to a CNN to identify spatial patterns. This yields abstract, high-level feature representations. At step 36, the spatial features are flattened or converted into a sequential format. This allows temporal learning models to process them. At step 38, sequence-based dependencies are learned. Temporal relationships in the data are learned using LSTM layers. These dependencies reflect execution patterns tied to malware behavior. At step 40, the LSTM outputs are passed to dense layers for final decision-making. Classification is based on patterns learned from temporal dependencies. At step 42, malware classification is achieved in which outputs provide probability distributions over malware family classes.

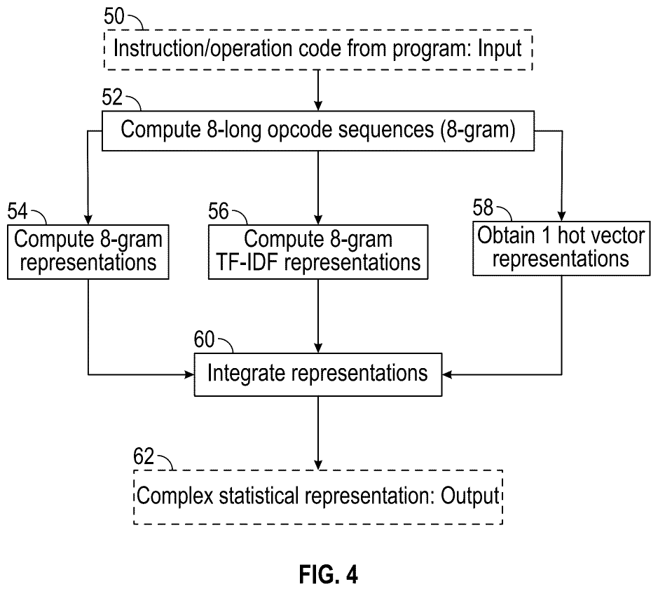

Referring to FIG. 4, this figure provides details on aspects of computing complex statistical representations of FIG. 3. At step 50, the opcode sequence is derived from the program is input. At this stage, the opcode sequence is ready for statistical feature analysis. At step 52, computation occurs for sequences of eight consecutive opcodes. This step captures local patterns in instruction sequences. At step 54, 8-gram sequences are encoded into vector form. These basic encodings are the foundation for further analysis. At step 56, term frequency-inverse document frequency (TF-IDF) is computed for each 8-gram. This computation highlights more informative patterns. At step 58, this step generates one-hot encoded vectors for opcode sequences. These vectors serve as another statistical input format. At step 60 multiple representations (TF-IDF, 1-hot) are combined or integrated into a unified format. This integration enriches the feature space for CNN processing. At step 62, the integrated output is a detailed statistical representation or set and this becomes the input for the CNN in the next step.

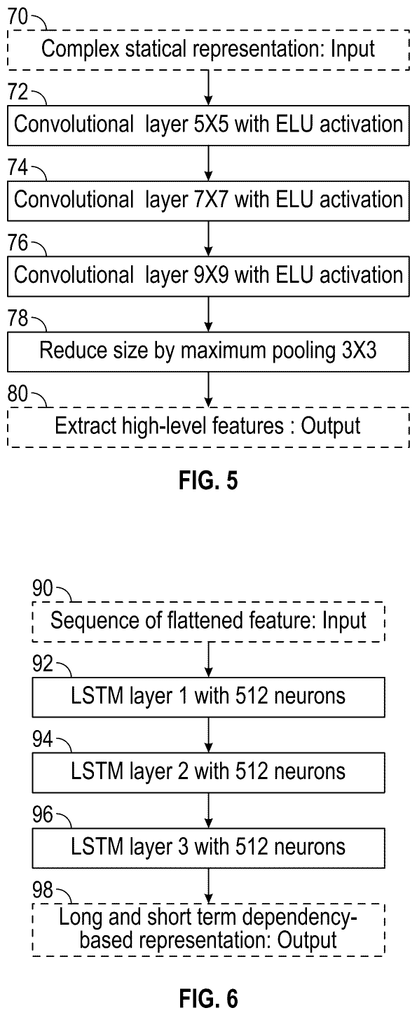

Referring to FIG. 5, this figure provides details on aspects of how to extract high level features of FIG. 3. At step 70 the input comprises rich statistical features generated earlier. The CNN layers transform these into abstract spatial features. At step 72, this involves convolution using 5×5 filters. ELU activation introduces non-linearity for better learning. At step 74, a deeper layer with wider filters is used to capture broader patterns. This layer helps in recognizing more complex relationships. At step 76, an even larger receptive field allows this layer to understand high-level abstractions. This layer is especially useful for distinguishing malware characteristics. At step 78, this step reduces feature map dimensions using max pooling. This step enables retention of dominant features while reducing computational cost. At step 80, an output is provided in the form of a set of abstract features ready for sequence modeling. These features represent meaningful patterns useful for classification.

Referring to FIG. 6, this figure provides details on learning sequence-based dependencies from FIG. 3. At step 90, the input is the sequential representation of features from the CNN. These features from the CNN are fed into the LSTM for temporal analysis. At step 92 the first LSTM layer learns basic temporal dependencies. This layer begins to capture the order and structure of features. At step 94, a deeper LSTM layer adds complexity to learned dependencies. This deeper layer improves the model's memory of longer sequences. At step 96, a final LSTM layer enhances representation with long-range context. The output becomes suitable for final classification. At step 98, the LSTM output represents both local and global dependencies.

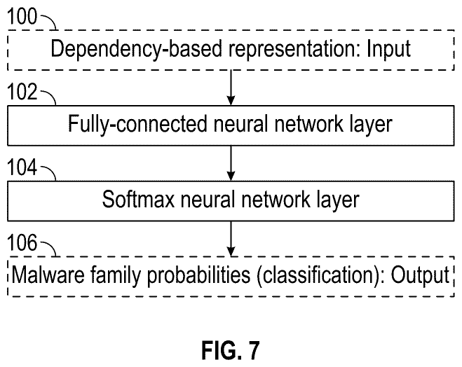

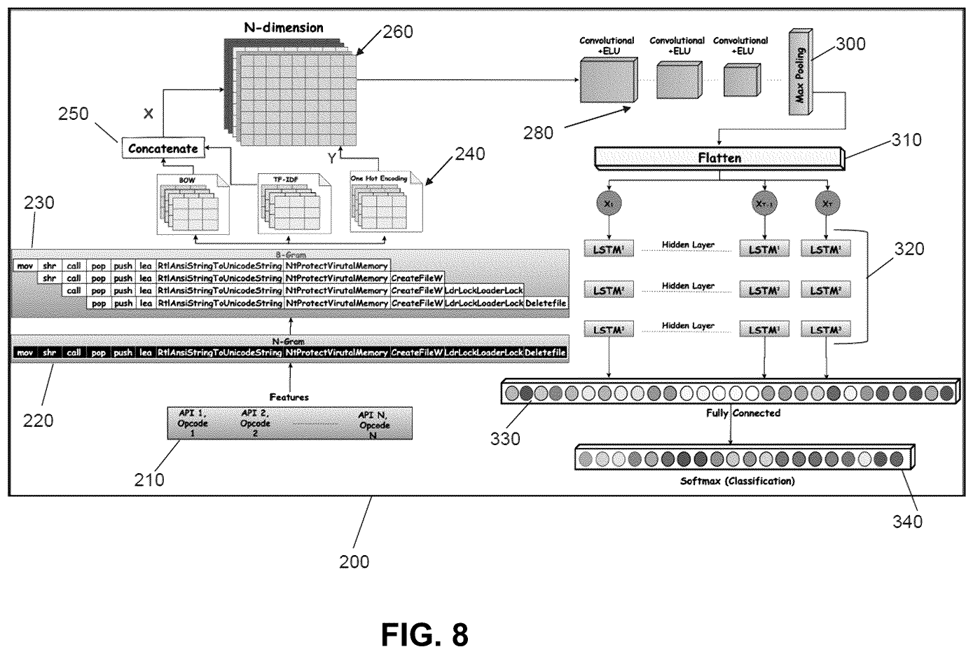

Referring to FIG. 7, this figure explains the final classification step using a dense neural network in which the dependency-based representation is passed through fully connected and softmax layers. At step 100, this step involved the LSTM-derived features representing dependencies in the code. These features are context-aware and rich in semantic information. At step 102, this fully connected neural network dense layer transforms learned dependencies into a decision space. This step reduces dimensionality while retaining information. At step 104, the neural outputs are converted into probability distributions. Each class receives a score representing its likelihood. At step 106, the final predicted probabilities for each malware class are generated. This step can be considered the methods final output.

FIG. 8 is a system diagram of the invention representing some of the functional aspects of the method of the invention in a graphical form. More specifically, this figure provides an example of a preferred embodiment of the invention in the form of a CNN-LSTM model with a hybrid architecture that first uses convolutional layers to extract spatial features from 8-gram sequences of API calls and opcodes. These extracted feature maps are then flattened and passed through a series of LSTM layers to learn temporal dependencies and contextual patterns. Finally, the output from the LSTM layers is fed into fully connected layers to classify the input into corresponding malware families. From a review of the flow path provided in FIG. 8, it should be apparent that the elements provided in this figure are consistent with the method explained above with respect to FIGS. 1-7. The system 200 is illustrated more particularly with elements labeled numerically as 210, 220, 230, 240, 250, 260, 280, 300, 310, 320, 330, and 340. These labelled elements correspond to the respective steps in the FIGS. 1-7. Although the invention has been set forth herein with respect to one or more embodiments, it should be understood that the invention is not strictly limited to these embodiments and the scope of the invention should be considered in total to include the figures, the description, and the scope of the appended claims.

What is claimed is:

1. A method for malware classification using convolutional neural networks and long short-term
memory, comprising:
providing data identified as malware;
processing the data to analyze the malware and to subsequently generate a malware classification in the form of malware family probabilities;
wherein the processing is conducted by a computer with a processor, and programable code is used to drive the processing; and
wherein the programable code includes a preprocessing module, a trainable multi-step classification module, and a final malware classification output in the form of the malware family probabilities.

2. A system for malware classification using convolutional neural networks and long short-term
memory, comprising:
computer processing means;
software means with computer coded instructions to execute a malware classification method; and
wherein the computer coded instructions include a preprocessing module, a trainable multi-step classification module, and a final malware classification output in the form of malware family probabilities.

3. A non-transitory computer-readable storage medium including program code which when
executed by at least one processor causes operations comprising:
computer instructions for providing data identified as malware;
computer instructions for processing the data to analyze the malware and to subsequently generate a malware classification in the form of malware family probabilities;
wherein the computer instructions for processing the data include a preprocessing module, a trainable multi-step classification module, and a final malware classification output in the form of the malware family probabilities.
